(19) United States
(12) Patent Application Publication
(10) Pub. No.: US 2018/0225784 A1
(43) Pub. Date: Aug. 9, 2018

(54) Real Estate Network System and Method of Use

(71) Applicant: Agentdesks Inc., San Francisco, CA (US)

(72) Inventor: Biju Ashokan, San Francisco, CA (US)

(73) Assignee: Agentdesks, San Francisco, CA (US)

(21) Appl. No.: 15/425,246

(22) Filed: Feb. 6, 2017

(51) Int. Cl. G06Q 50/16; H04L 29/08; H04L 12/58; G06Q 10/10

(52) U.S. Cl. CPC G06Q 50/16; H04L 67/306; G06Q 50/01; H04L 51/16; G06Q 10/1095; H04L 67/18

(57) ABSTRACT

Disclosed is a device, system, and method that includes a network interface device communicatively coupled to a processor that is configured to provide network groups and facilitate real estate transactions. Each user in the system is a member of at least one network group, wherein the network group can be based on a geographic location of the user, the user's professional affiliations, and/or other criteria. The user's property databases are integrated with the system to share property listings within network groups and generate leads based on matching property requirements. Real estate transactions can be conducted via a messaging platform of the system, wherein the messaging platform consolidates electronic messages to maintain a single communication thread.

### FIELD OF THE INVENTION

The present invention relates generally to online real estate transaction systems. More particularly, the present invention is directed to a system and method for creating and managing social networks for real estate agents in order to facilitate real estate transactions and generate leads with an increased sales conversion rate.

### BACKGROUND OF THE INVENTION

Managing real estate transactions can be a complex and laborious task. Many real estate agents and brokers are generally expected to manage a large client base and property listings while manually coordinating with other real estate agents and brokers to facilitate renting, buying, and selling of commercial and residential properties on an individual basis. Additionally, it is highly valuable for real estate agents to be adept at generating leads in an efficient manner in order to grow a business and be marketable.

Currently, some real estate agents utilize CRM solutions or similar tools that are tailored towards large brokerage firms. In this regard, these tools do not allow an agent or a broker to build a network using a bottom-up technique. Additionally, these CRMs do not allow agents to collaborate with other agents and generate agent leads from other agents. In this regard, the invention described herein addresses this problem by disclosing a networking system that enables agents and brokers to share available properties and property updates.

Various systems have been disclosed in the prior art that facilitate real estate transactions. These systems are described herein for the purposes of highlighting and differentiating the unique aspects of the present invention, and further highlighting the drawbacks existing in the prior art.

For example, WO 2015/030683, US 2013/0304657, and US 2004/0030631 disclose systems that allow a homebuyer to search for and view real properties for sale. These systems focus on reducing the number of unnecessary showings that the buyer's real estate agent would have to arrange with the seller. The homebuyer can also communicate with various parties, such as the seller, realtors, and other individuals. These systems, however, do not allow a realtor to communicate with other realtors and real estate agents.

Additionally, these systems require the buyer to personalize their research parameters for a particular real estate target or initiate the process of searching for properties for sale, wherein property listing can be prioritized based on the buyer's preference, as disclosed in U.S. Pat. No. 8,666,792. In this regard, these systems lack means for generating leads for realtors and real estate agents.

Other systems, US 2015/0170300, are configured to manage real estate agent relationships by automatically determining consumer needs and enabling real estate agents to vary style, content, and frequency of communications with other users. However, these systems create a network of clients rather than a network of real estate agents for generating leads.

The systems disclosed in the prior art have several known drawbacks, however. These systems are limited in that they do not disclose a networking system for real estate agents, wherein the system can be used for automatically generating leads, managing listings, and receiving listing status updates. The present invention overcomes these limitations by disclosing a networking system for real estate agents, wherein the agents can create and join virtual community groups based on location, affiliation, and/or interest to share property listings, identify new opportunities, and facilitate transactions.

### SUMMARY OF THE INVENTION

In view of the disadvantages inherent in the known types of systems for facilitating real estate transactions now present in the prior art, the present invention provides an improved system and method for creating and managing networks of real estate agents for facilitating real estate transactions and generating leads.

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

In some embodiments, the present system comprises at least one user device in communication with a server over a network, wherein the user device and the server comprise various types of computer systems, preferably smartphones, tablet computers, or personal digital assistants (PDAs). It should be understood that system and method of the present invention are generally taught and disclosed in terms of mobile computing, but the same principles are applicable to nearly any device capable of executing a machine-readable instruction.

The user device and the server comprise a memory unit having instructions stored thereon, and a processor that is operatively connected to the memory unit for executing the instructions to result in an application. The application comprises a web application, a mobile application, a website, a mobile site, a plug-in, or other types of non-downloadable or downloadable software applications.

The frontend of the application is configured to allow an end user, such as a real estate agent and/or a real estate broker, to create an account and create or join one or more private and/or public networks of agents, for example, by using a user interface. The user can communicate with other agents via a messaging platform to generate new leads, share calendar events, organize meetings, and/or conduct various real estate transactions. Without limitation, it is further contemplated that the user can utilize the application to consolidate, manage, and maintain property listings, leads, client and agent contact information, as well as requirements, matches, leads, and the like.

In some embodiments, the application is further configured to provide notifications to the user based on personalized settings. Non-limiting examples of notifications include alerts for newly received messages, newly listed properties, newly found matches, updates on listings, newly received invitations to join a network group, and the like. Accordingly, the present system enables the end users to obtain the most up-to-date and pertinent information about property listings in an organized manner.

In the light of the foregoing, these and other objectives are accomplished in accordance with the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 is an exemplary block diagram of the present system.

FIG. 2 is an exemplary block diagram of various components or functional modules of the present system.

FIG. 3 is an exemplary logic workflow of joining network groups.

FIG. 4 shows an exemplary logic workflow of creating private groups.

FIGS. 5 and 6 show exemplary logic workflows of adding properties and requirements.

FIG. 7 shows an exemplary logic workflow of messaging.

FIG. 8 shows an exemplary logic workflow of viewing feed.

FIG. 9 shows a block diagram illustrating components of a machine able to read instructions from a machine-readable medium.

### DETAILED DESCRIPTION OF THE INVENTION

The present invention is directed towards a networking system and method for creating and managing networks of real estate agents for facilitating real estate transactions and generating leads. For purposes of clarity, and not by way of limitation, illustrative views of the present system and method are described with references made to the above-identified figures. Various modifications obvious to one skilled in the art are deemed to be within the spirit and scope of the present invention.

Certain embodiments are described herein as including logic or a number of components, modules, system, interface, or mechanisms, which are generally intended to refer to a computer-related entity, either software modules (e.g., code embodied on a machine-readable medium or in a transmission signal), hardware modules, or a combination thereof. A hardware module is a tangible unit (e.g., a computer system, a processor) capable of performing certain operations and may be permanently or temporarily configured or arranged in a certain physical manner. In various example embodiments, one or more computer systems or one or more hardware modules of a computer system may be configured by software as a hardware module that operates to perform certain operations as described herein. Additionally, one or more components, modules, system, interface, or mechanisms can reside within a process and/or thread of execution and a component, module, system, interface, or mechanism can be localized on one computer and/or distributed between two or more computers.

Similarly, the methods described herein may be at least partially processor-implemented. For example, at least some of the operations of a method may be performed by one or more processors or processor-implemented modules, wherein performance of certain of the operations may be distributed among the one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., I/O components, associated processor, application, and/or an application program interface (API)).

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Discussions herein utilizing terms such as, for example, “processing,” “computing,” “calculating,” “determining,” “establishing,” “identifying,” “analyzing,” “checking,” or the like, may refer to operations(s) and/or process(es) of a computer, a computing platform, a computing system, or other electronic computing device, that manipulate and/or transfer data represented as physical (e.g., electronic) quantities within the computer's registers and/or memories into other data similarly represented as physical quantities within the computer's registers and/or memories or other information storage medium that may store instructions to perform operations and/or processes.

As used herein, the word “exemplary” means serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.”

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. In this regard, the articles “a” and “an” as used in this application and the appended claims should generally be construed to mean “one or more” or “at least one” unless specified otherwise or clear from context to be directed to a singular form.

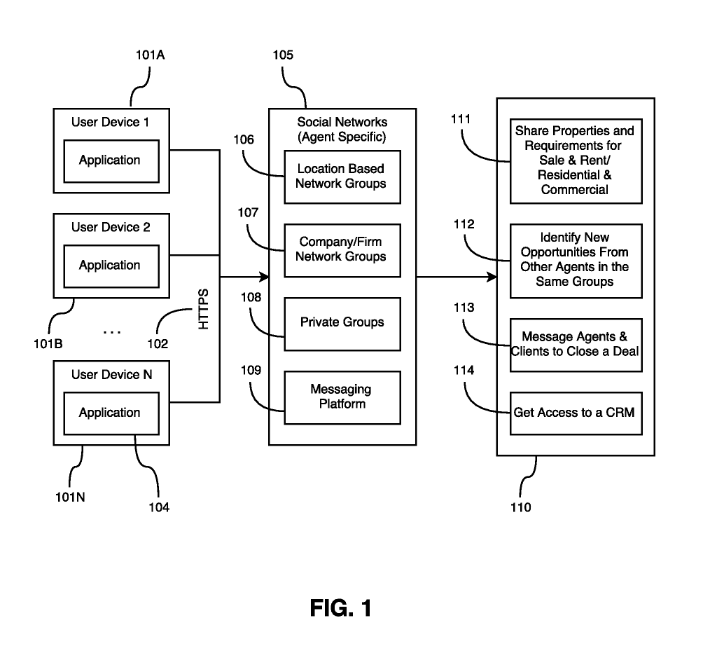

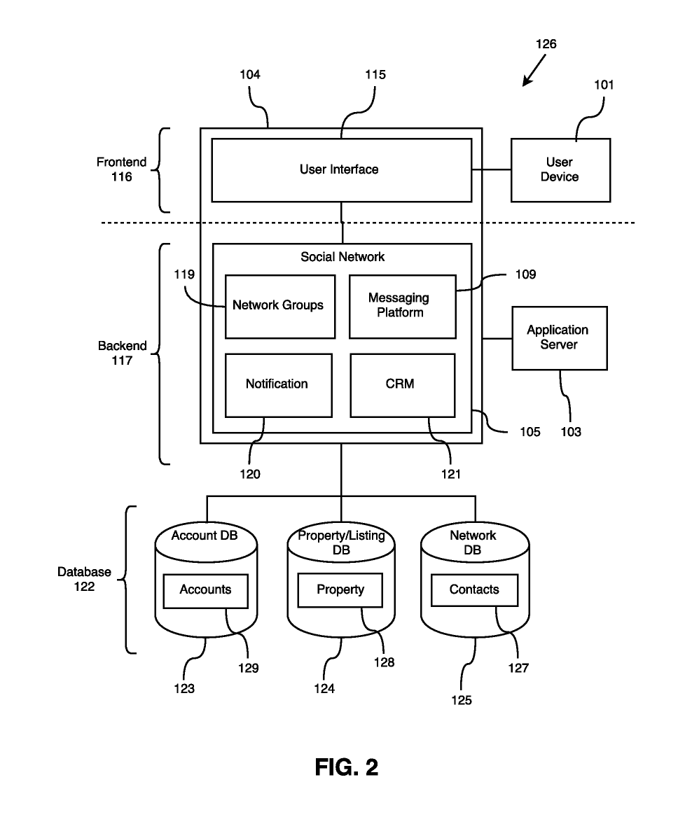

Referring now to FIGS. 1 and 2, there are shown block diagrams of the components and functional modules of the present system. The present system 126 includes one or more network-enabled user devices 101A, 101B, 101N in communication with a network 105, wherein the user devices 101A, 101B, 101N are operated by end users. As used herein, the term “end user(s),” “real estate broker(s),” “realtor(s),” “real estate agent(s),” are used interchangeably unless the context clearly suggests otherwise. The user devices 101A, 101B, 101N comprise a memory unit having instructions stored thereon, and a processor that is operatively connected to the memory unit for executing the instructions to result in an application 104. The application 104 comprises a web application, a mobile application, a website, a mobile site, a plug-in, or other types of non-downloadable or downloadable software applications.

The frontend 116 of the application 104 comprises a user interface (UI) 115 for receiving user input or requests (e.g., HTTP requests 102, API requests, etc.) from various user devices 101A, 101B, 101N, and displaying appropriate responses or information to the requesting user devices 101A, 101B, 101N. The backend 117 of the application or the application logic layer includes an agent-specific social network 105 comprising a module for managing network groups 119, wherein the module 119 can manage network groups within the social network 105 based on data retrieved from the database layer 122. For example, the module 119 can be configured to assign or associate users with appropriate network groups based on the users' needs or information associated with the users. In some embodiments, the module 119 is further configured to send invitations to users to join certain network groups and recommend users to join certain network groups. Non-limiting examples of network groups include location-based network groups 106, company/firm network groups 107 or organization based network groups, private networks groups 108, and other network groups based on different criteria. It is contemplated that the network groups may be private or public.

Each user is associated with at least one network group. When a new real estate agent is added to a user's contacts or address book stored within the application 104 or stored locally on the user device 101, the application 104 can automatically add the agent to one or more of the user's network group based on the agent's information (e.g., business or professional affiliations and organizations, geographical location, employment information, interests, etc.). Alternatively, the application 104 can automatically or manually (i.e., upon receiving a user request) send invitations to the agent to join a network group. Additionally, the user can invite or un-invite an agent to his or her network group without adding the agent to his or her contacts or address book. For example, the user may invite one or more agents in other network groups to join his or her network group. Moreover, the user can invite another agent to his or her network group by entering the agent's email address and/or selecting the agent's contact information from the user's address book. The user can view member profile information, including contact information, property listings, matches, testimonials and client reviews, and activities of agents that are in the user's network group. In some embodiments, the user can un-invite an agent or remove an agent from a network group if the user is an administrator of the network group.

The network 105 further includes a customer relationship management (CRM) tool 121 that is accessible via the UI 115, which in conjunction with the UI 115, may generate various user interfaces with data retrieved from various data sources in the data layer 122. The CRM 121 allows the user to organize contacts 127 and properties 128 related to a user account 129 that is managed by the end user. The user can add clients, real estate agents, properties, or other types of contacts 127 manually or automatically (e.g., via importing, migration, uploading) to his or her account. The user can import contacts 127 from various sources. In some embodiments, the user can import contacts 127 that are locally stored on his or her user device 101, stored on a cloud, or stored on a remote database. In another embodiment, the user can import contacts 127 from his or her address book that is associated with his or her email address or email account.

Additionally, the network 105 includes a messaging platform 109. The messaging platform is configured to allow users to send to and receive content from other users. Non-limiting examples of content include electronic messages, posts, links, images, and videos. The network 105 also includes a notification module 120 that is configured to provide notifications to the user, wherein the notifications can be customized based on the user's preferences. Non-limiting examples of notifications include notifications for new listings, new client matches, new agent matches, new leads, calendar/meeting invites, and the like. In this regard, the application 104 centralizes and manages information pertaining to clients, other agents, property listings, and leads.

The database layer 122 includes several databases 123, 124, 125, such as an account database 123 for storing account-related information correlating to individual users as well as entity users. The application 104 is configured to enable a user to create a user account when initially accessing the application 104. In this regard, the user is prompted to provide account-related information, including name, username, password, contact information, business or professional affiliations and organizations, geographical location, employment information, interests, and other personal information in order to create a member profile. Similarly, the application is configured to prompt a representative or an agent of an organization to provide information about the organization. This information may also be stored in the account database 122. Additionally, account-related information can comprise user preferences so as to allow a user to set user preferences for his or her user account.

The database layer 122 further comprises a property/listing database 124 for storing information related to listings or properties for sale, rent, or lease. In some embodiments, the application 104 is configured to communicate with third party service providers to continuously receive property listing information therefrom, or utilize a web crawler to gather information related to properties/listings over the Internet. In some embodiments, the application 104 is configured to enable a user to manually input or upload information related to a property/listing, including listing price, rent, location, the number of bedrooms and bathrooms, the type of property, and photographs, if any. In some embodiments, the end user can migrate or add details about properties or listings from the user's website or from a third party service.

When a property is added to the property/listing database 124 of the system 126, the end user can associate the property with a new or an existing client. The application 104 is configured to retrieve information pertaining to properties stored in the property/listing database 124 to match one or more properties with each of the end user's clients. More specifically, the application 104 is configured to compare the requirements of a client with the details of a property to determine whether the property meets all or most requirements of the client. In this way, the present system automatically matches clients with listings for properties that meet the clients' needs. For instance, the present system would match a client seeking a three-bedroom house with a listing for a house having three bedrooms, but not one bedroom. In another example, the present system would not match a client seeking a studio apartment for rent with a two-bedroom house for sale. If there is a match, the application 104 is configured to share properties and requirements for sale or rent for residential or commercial properties 111. In some embodiments, however, the user can manually share property listings with clients by using in-app messaging and/or sending links directly to the clients.

In some embodiments, the application 104 is further configured to calculate the match percentage for each property that meets at least some of the client's requirements. In this regard, the matches may be displayed in order of the highest match percentage to the lowest match percentage to display the most relevant properties first. If a match percentage is above a predetermined threshold, the user can contact the agent of the listing for the matching property via the messaging platform 109.

The messaging platform 109 allows the user to share pictures, videos, and/or links, to obtain additional details about the property. Additionally, the user can share news articles, blogs, and other information relating to real estate transactions. Moreover, the user can organize meetings, open house events, and/or share calendars to facilitate selling and buying of the property in question. If the property is not a good match for a particular client (i.e., a match percentage is below the predetermined threshold or the client does not want the property), the user can flag the listing so that it no longer shows as a match for that particular client.

The application 104 is further configured to generate leads by comparing the requirements of a buyer or a seller of an agent with the details of a property being sold or sought, thereby identifying new opportunities from other agents within the same network groups 112. When matches are found, the UI 115 can display property and buyer matches for each agent. In one embodiment, the agent can be within or outside of the user's network group. If the agent is outside of the user's network, the user can invite the agent to his or her network group. In this regard, the present system allows real estate agents to generate leads using CRM.

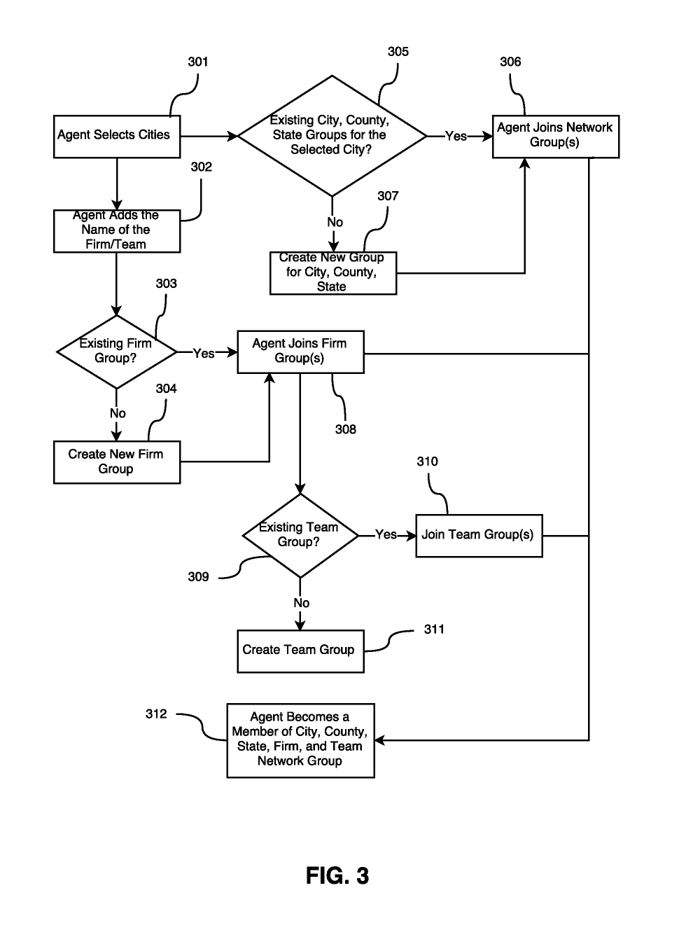

References are also made to FIG. 3 through 7, which schematically illustrate exemplary methods of the present invention. In some embodiments, one or more operations of FIGS. 3 through 7 may be performed by one or more elements of the system as described in FIGS. 1 and 2.

Referring now to FIG. 3, there is shown an exemplary logic workflow of joining or creating location based and company/firm based network groups. As disclosed above, the network comprises location-based network groups, company/firm network groups, private network groups, and other network groups based on different criteria. As indicated in block 301, an agent selects cities in which he or she is located or in which he or she conducts business during the account creation process. As indicated in block 305, the application determines whether there is an existing network group associated with the agent's city, county, or state. If there is no network group for the city, county, or state, the application creates a new network group for the agent's city, county, or state. Thereafter, the agent can join the network group for the new city, county, or state 306.

As indicated in block 302, the agent adds the name of the firm or team to which he or she is affiliated or employed or to which he or she represents. The application determines whether there is an existing network group associated with the agent's firm 303. If there is no existing network group for the firm, the application creates a new network group for the agent's firm 304. The agent can thereafter join the network group for the agent's firm 308. The application then determines whether there is an existing network group for the agent's team 309. If there is no existing network group for the agent's team, the application creates a new network group for the agent's team 311. Thereafter, the agent can join the network group for the agent's team 310. In this regard, the agent becomes a member of a network group for a city, county, state, firm, and team 312 to which he or she is associated. Upon joining a network group, the agent's network group membership information is reflected in the agent's member profile.

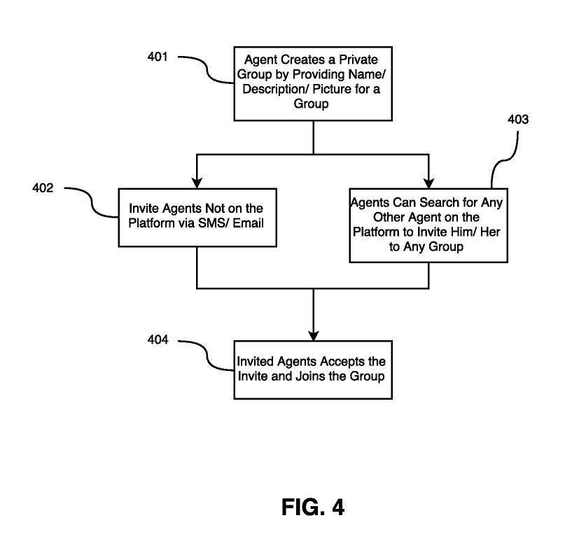

Referring now to FIG. 4, there is shown an exemplary logic workflow of creating and joining private groups. As indicated in block 401, an agent can create a private group by providing name, description, and/or a picture for the group, for example, via the UI. The agent can also specify criteria for becoming a member of the private network group. For example, an agent may be eligible for the membership based on an agent's performance, type of transactions handled by the agent, or the agent's affiliation with certain organizations or associations (e.g., professional organizations, regional associations, institutional organizations, cultural organizations, etc.).

As indicated in block 402, the agent, via the application, can invite other agents not on the social network platform, for example, via SMS or email. Alternatively, the application allows agents to search for other agents on the social network platform to invite them to a network group 403. As indicated in block 404, invited agents can accept the invite and join the group. Upon joining a network group, the agent's network group membership information is reflected in the agent's member profile.

Within network groups, group members can share or post property listings, information relating to properties, requirements for lease or sale, news articles, images, listing statuses, property status changes, open house event, and other event announcements, for example, via a virtual message board, a bulletin board, or a conversation page. Other agents or group members can respond to posts liking, commenting, or directly messaging the group member who posted. For open house events, all agents (i.e., agents that are members or non-members of network groups) that can view the announcement can RSVP and add the open house event to their calendar.

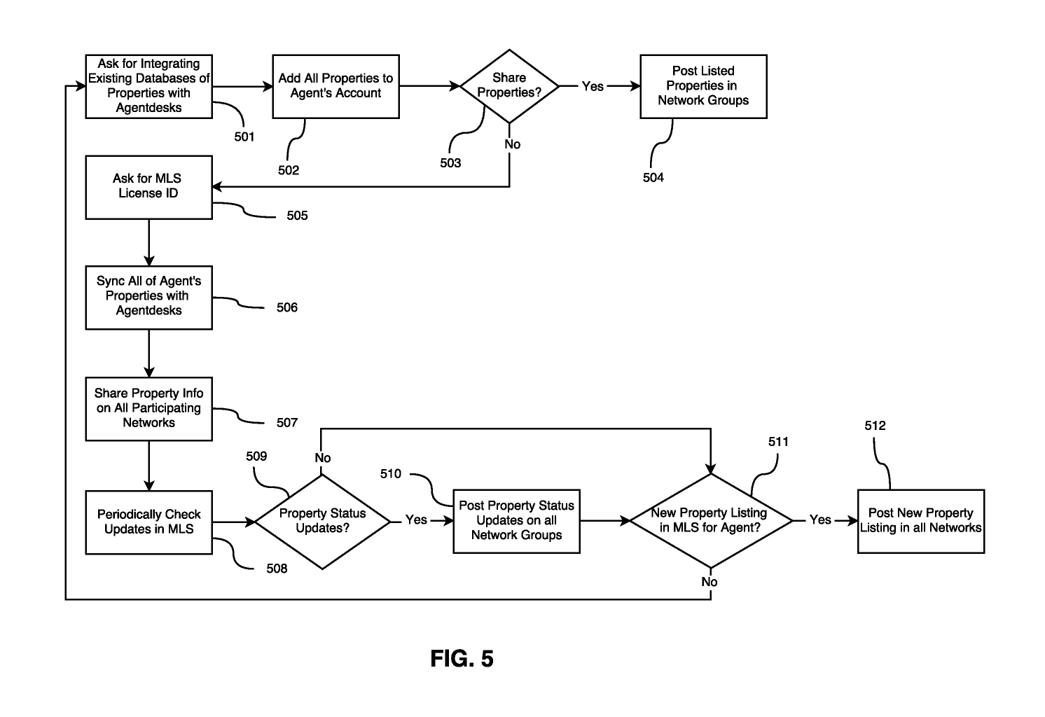

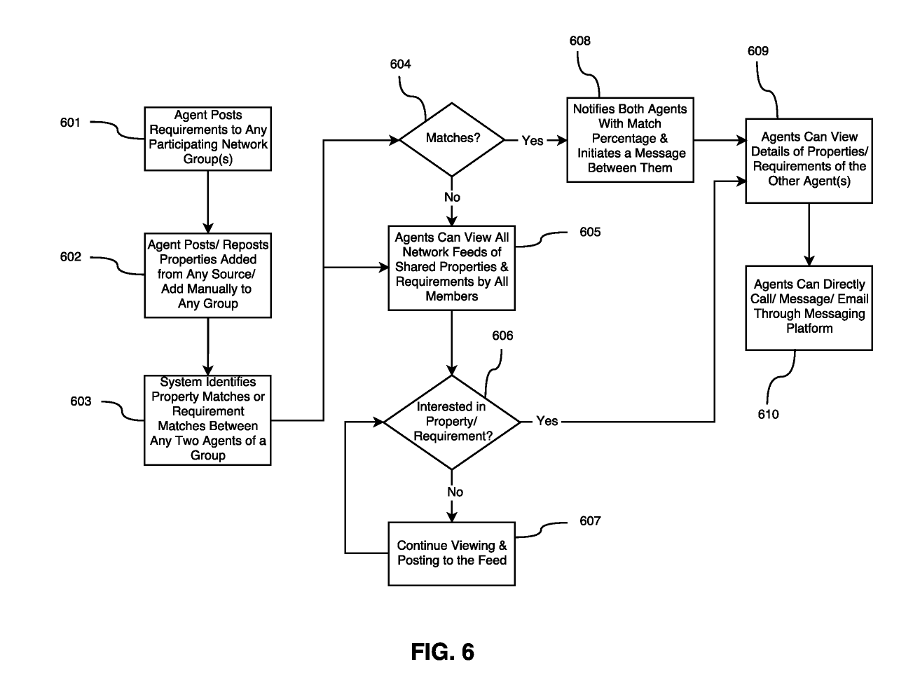

Referring now to FIGS. 5 and 6, there are shown exemplary logic workflows of adding properties or listings and requirements for renting or purchasing the properties. As indicated in block 501, the application prompts a user to integrate, existing databases of property listings with the application. The existing databases of property listings are added to the agent's user account 502. If the user wants to share his or her property listings 503, the user, via the application, can post (e.g., on a virtual message board, a bulletin board, or a conversation page) listed properties in the user's network groups 504. The agent can manually add posts to any network group to which he or she is a member.

As indicated in block 505, the application prompts for the Multiple Listing Service (MLS) license ID 505 to integrate MLS. Optionally, the application prompts the user to provide other sources to import the user's property listings. As indicated in block 506, the application syncs all of the agent's property listings with the application. As indicated in block 507, the application enables the user to share property listings and related property information on all of the user's participating network groups. For example, the application can post the listings and the property information in the user's network groups. As indicated in block 508, the application automatically checks updates in MLS at regular time intervals. If there are any status updates to the property 509, the application posts property status updates on all of the user's network groups 510 or updates the user's post. As indicated in block 511, if there is a new property listing in MLS for the agent, the application automatically posts the new property listing on all of the user's network groups 512.

As indicated in block 601, an agent, via the application, can post requirements for renting or purchasing a property for lease or sale, respectively. As indicated in block 602, the agent can post or repost property listings from any source, including his or her own databases of property listings, third party service providers, and other agents' posts. Sharing requirements and properties with other members of a network group allow the application to automatically generate leads and matches. Additionally, other members can view property listings and requirements for lease or sale and contact the listing agent directly through the messaging platform. As indicated in block 603, the system identifies property matches or requirement matches between any two agents of a network group via CRM.

In this regard, the application determines a match by calculating a match percentage. The match percentage is calculated by comparing a set of fields or factors between a property for lease or sale and requirements for lease or sale. Each of the fields or factors comprises weighting associated therewith. The amount of weight associated with the fields or factors can be customized by the agent based on client needs. For example, the price or budget for purchasing or renting a property can be given more weight a the age of the property. Thus, in an exemplary embodiment, the sum of the weight of all of the fields or factors matched is divided by the total night of all of the factors and then multiplied by 100 to calculate the match percentage.

Non-limiting examples of other fields or factors include: budget range versus the price of the property; neighborhood preference versus the location of the property; minimum number of bedrooms and bathrooms desired versus the number of bedrooms and bathrooms of the property; size preferences (i.e., square footage) versus the actual size of the property; property type (e.g., apartment, condominium, single family home, etc.); property availability and status (e.g., off the market, under renovation or construction, under repair, offers received, price increase or decrease, etc.); and amenities or perks desired versus amenities or perks available (e.g., view, pool, deck, gym, security, garage, etc.).

In some embodiments, the application determines that there is a good match if the match percentage is above a predetermined threshold, wherein the user can set the predetermined threshold. For example, the user may wish to only view matches with over 75% match percentage. In some embodiments, the application is configured to provide a list of matches, in order from the highest match percentage to the lowest match percentage.

If there is a good match 604, the application notifies both buying and selling agents with a match percentage and initiates a message between the two agents 608 via the messaging platform. If there are no matches, the agents can browse or view all network group feeds of shared properties and requirements by all agent members 605. If the agent is interested in a property 606, the agents can view details about the properties or requirements of the other agent 609. The agent can continue viewing and posting to the feed 607 until the agent finds a property that he or she is interested in. After viewing details of the property, the agent can directly call, message, or email other agents through the messaging platform 610.

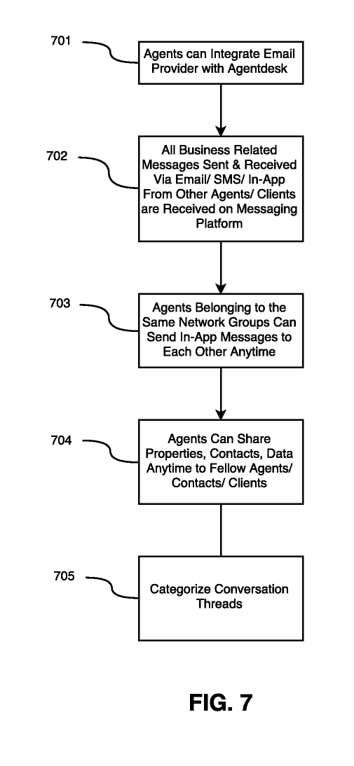

Referring now to FIG. 7, there is shown an exemplary logic workflow of messaging. As indicated in block 701, agents can integrate the agent's email provider with the application. More specifically, the application directs the user to enter his or her email credentials and allow permissions to allow the application to access required content. In this way, all messages sent and received via email, SMS, or in-app messaging to and from other agents, clients, or other contacts are received on the messaging platform within the application 702. In some embodiments, the application is configured to enable clients to freely communicate with his or her real estate agents using the messaging platform. As indicated in block 703, agents belonging to the same network groups can send in-app messages to each other at any time using the messaging platform. As indicated in block 704, agents can share properties, contacts, deal, critical data, or other transactional documents at any time to fellow agents, contact, or clients.

Because the messaging platform integrates with emails, SMS, voice, and in-app messaging, the application can provide a timeline of all of the communications or conversations between an agent and an agent or an agent and a client in a single chat thread regardless of the channel of communication. For example, when an agent sends a message via email and then a client replies to the message via. SMS, the agent's message and the client's reply is displayed in a single thread with a time stamp next to each message and reply. In this way, the messaging platform centralizes all communication and provides an all-inclusive view of messages exchanged to increase convenient to all users and increase the sales conversion rate. Additionally, these conversations can be organized or categorized by property, agent, or other transaction indicators 705. For example, a conversation thread can be categorized under a street address for a property.

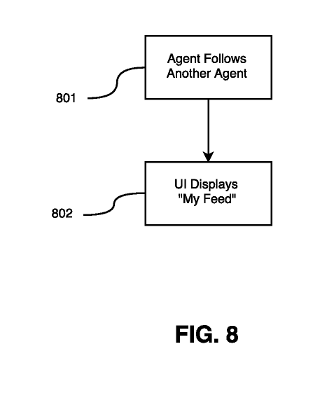

Referring now to FIG. 8, there is shown an exemplary logic workflow of receiving information feed. As indicated in block 801, an agent can follow or subscribe to another agent within or outside of his or her network groups. Upon following or subscribing to another agent, the application enables the agent to receive the other agent's feed, which includes communications sent by the other agent. For example, the communications comprise the other agent's status updates, shared posts, links, messages, notifications, and the like.

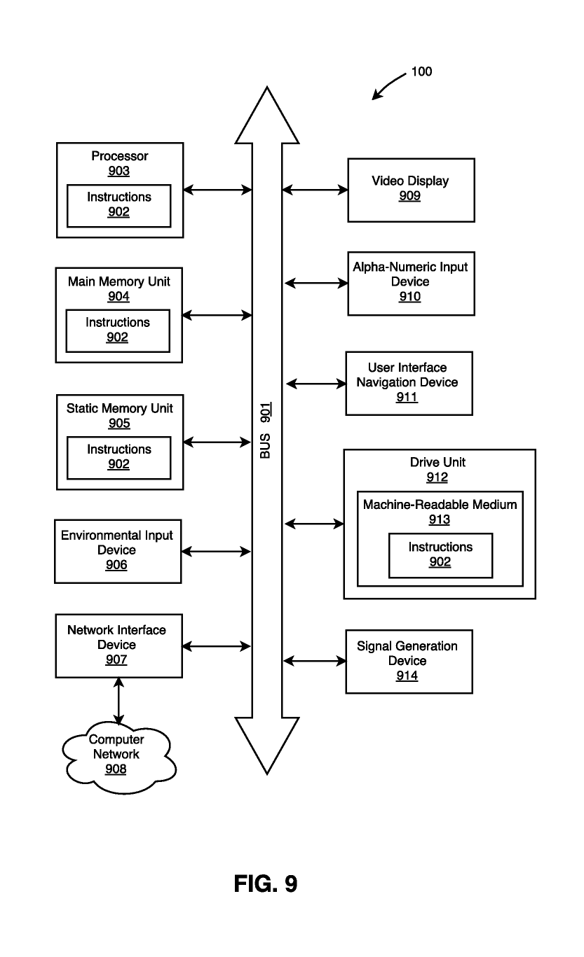

FIG. 9 is a block diagram illustrating components of a user device 100 or a machine, according to some example embodiments, able to read instructions from a machine-readable medium and perform any one or more of the method steps as discussed herein. Specifically, the machine comprises a computer system and within which instructions 902 (e.g., software) for causing the machine 100 to perform any one or more of the methodologies discussed herein may be executed. The machine 100 operates as a standalone device or may be connected to other machines in one or more geographical locations in a network (e.g., to provide information to, and receive information from, other machines). In a networked deployment, the machine 100 may operate in the capacity of a server machine or a client machine in a server-client network environment, or as a peer machine in a peer-to-peer (or distributed) network environment. Further, while only a single machine is illustrated, the term “machine” shall also be taken to include a collection of machines that individually or jointly execute the instructions 902 to perform any one or more of the methodologies discussed herein. In embodiments in which multiple hardware modules are configured or instantiated at different times, communications between such hardware modules may be achieved, for example, through the storage and retrieval of information in memory structures to which the multiple hardware modules have access.

The machine 100 may be a server computer, a client computer, a personal computer (PC), a tablet computer, a desktop computer, a laptop computer, a netbook, a set-top box (STB), a handheld device (e.g., personal digital assistant (PDA), a smartphone, etc.), a tablet computer, a web appliance, a network router, a network switch, a network bridge, a wireless access point (AP), a wired or wireless router, a wired or wireless modem, a wired or wireless network, a local area network (LAN), a wireless LAN (WLAN), a metropolitan area network (MAN), a wireless MAN (WMAN), a wide area network (WAN), a wireless WAN (WWAN), a personal area network (PAN), a wireless PAN (WPAN), or networks operating in accordance with existing and/or future versions and/or derivatives of long-term evolution (LTE), a device which incorporates a global positioning system (GPS) receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, or any machine capable of executing the instructions 902, sequentially or otherwise, that specify actions to be taken by that machine.

The machine 100 includes a processor 903 (e.g., a central processing unit (CPU), a graphics processing unit (GPU), a digital signal processor (DSP), an application-specific integrated circuit (ASIC), a radio-frequency integrated circuit (RFIC), etc.), a main memory unit 904, and a static memory unit 905, which are configured to communicate with each other via a bus 901.

The machine 100 may further include a video display 909 (e.g., a plasma display panel (PDP), a light emitting diode (LED) display, a liquid crystal display (LCD), a projector, or a cathode ray tube (CRT)). The machine 100 may also include a network interface device 907, an alphanumeric input device 910 (e.g., a keyboard), a user interface navigation device 911 (e.g., a mouse, a touchpad, a trackball, a joystick, a motion sensor, or other pointing instruments), a drive unit 912, and a signal generation device 914 (e.g., a speaker).

The drive unit 912 includes a machine-readable medium 913 on which is stored the instructions 902 embodying any one or more of the methodologies or functions described herein. The instructions 902 may also reside, completely or at least partially, within the processor 903 (e.g., within the processor's cache memory), within the main memory 904, and/or within the static memory unit 905. Accordingly, the processor 903, the main memory 904, and the static memory unit 905 may be considered as machine-readable media. The instructions 902 may be transmitted or received over a computer network 908 via the network interface device 907.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 913 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 100), such that the instructions, when executed by one or more processors of the machine (e.g., processor 903), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

### A Scenario for Operation

The following lists of events may be considered a more concrete example of the functionality of the present invention, in a realistic scenario involving real estate agents and clients. In this scenario, the functionality of the system, as more generally shown in FIGS. 1 through 8, is designated by the term “Agentdesks,” which might be deemed to be the commercial trade name of such a product/service offering.

Step 1: A real estate agent obtains Agentdesks either as a license or as an online subscription of a web offering such as a mobile site, a mobile application, or the like.

Step 2: The real estate agent creates an account on Agentdesks to join network groups, generate leads, manage and view property listings, and conduct real estate transactions. The following methods are non-limiting examples of methods for entering account information relating to the real estate agent in the system: a) the real estate agent can enter his or her own information, via a UI; b) information relating to the real estate agent is automatically imported from third party sources using an import tool.

Step 3: A member profile that is associated with the agent's account is created and the agent joins one or more network groups based on his or her location and company/firm affiliation.

Step 4: The real estate agent creates a private network group for selling agents with pocket listings and sends invitations an invitation to another agent via email. If the other agent accepts the invitation but does not have an Agentdesks account, the other agent is prompted to create an account as described above before joining the private network group.

Step 5: All of the agent's property listings from various databases are integrated with his or her Agentdesks account. The agent enters sale requirements and other information relating to properties in the property listings. The agent shares the sale requirements and other information relating to the properties with other agents in his or her network groups.

Step 6: Agentdesks finds a property that matches the agent's sale requirements by calculating a match percentage for each property shared in the network group.

Step 7: The agent sends a message to an agent associated with the matching property via Agentdesk's messaging module.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system, comprising:
a computer readable medium comprising instructions which, when implemented on a processor, cause said processor to perform operations, comprising:
maintain a member profile for a user account in a network system comprising network groups, wherein said member profile comprises a geographic location of a user and a company affiliated with said user;
identify one or more network groups associated with said geographic location and said company affiliated with said user;
associate said user account with said one or more network groups associated with said geographic location and said company affiliated with said user;
integrate property databases associated with said user with said user account to add property listings within said property databases to said user account, wherein each of said property listings is associated with a property;
share said property listings in said one or more network groups associated with said geographic location and said company affiliated with said user;
provide a messaging platform comprising a conversation thread comprising a plurality of electronic messages related to one of said property listings exchanged between said user and a second user.

2. The system of claim 1, wherein said instructions further cause said processor to:
receive property requirements for said property, wherein said property requirements comprise requirements for selling said property or leasing said property, further wherein said requirements for selling said property or leasing said property comprises a set of weighting factors that contribute to a determination of a match percentage.

3. The system of claim 2, wherein said instructions further cause said processor to:
calculate said match percentage by comparing said set of weighting factors of said property requirements and correlating factors of said property;
determine that said property is a matching property if said match percentage is above a predetermined threshold;
display said matching property in a user interface.

4. The system of claim 3, wherein said instructions further cause said processor to:
provide notifications to said user and said second user upon identifying said matching property and receiving said plurality of electronic messages.

5. The system of claim 1, wherein said one or more network groups comprise a private network group;
wherein said instructions further cause said processor to create a private network group within said network system;
wherein said private network group comprises a membership requirement.

6. The system of claim 1, wherein said instructions further cause said processor to:
transmit an invitation from said user to said second user to join said one or more network groups.

7. The system of claim 1, wherein said messaging platform is configured to:
integrate an email address of an email account associated with said user;
consolidate said plurality of electronic messages into a single conversation thread, wherein said plurality of electronic messages can be transmitted and received via said email address of said email account, SMS, and said messaging platform.

8. The system of claim 1, wherein said instructions further cause said processor to:
share calendar events with a plurality of users;
receive RSVPs for said calendar events from said plurality of users.

9. The system of claim 1, wherein said instructions further cause said processor to:
update said property listings upon detecting updated information related to said property listings;
display said updated information related to said property listings in said one or more network groups.

10. The system of claim 1, wherein said instructions further cause said processor to:
follow a second member profile for a second user account associated with said second user;
display a user feed comprising one or more communications sent by said second user.

11. A computer-implemented method for facilitating real estate transactions and generating leads, the method comprising the steps of:
maintaining a member profile for a user account in a network system comprising network groups, wherein said member profile comprises a geographic location of a user and a company affiliated with said user;
identifying one or more network groups associated with said geographic location and said company affiliated with said user;
associating said user account with said one or more network groups associated with said geographic location and said company affiliated with said user;
integrating property databases associated with said user with said user account to add property listings within said property databases to said user account, wherein each of said property listings is associated with a property;
sharing said property listings in said one or more network groups associated with said geographic location and said company affiliated with said user;
providing a messaging platform comprising a conversation thread comprising a plurality of electronic messages related to one of said property listings exchanged between said user and a second user.

12. The method of claim 11, further comprising the steps of:
receiving property requirements for said property, wherein said property requirements comprise requirements for selling said property or leasing said property, further wherein said requirements for selling said property or leasing said property comprises a set of weighting factors that contribute to a determination of a match percentage.

13. The method of claim 12, further comprising the steps of:
calculating said match percentage by comparing said set of weighting factors of said property requirements and correlating factors of said property;
determining that said property is a matching property if said match percentage is above a predetermined threshold;
displaying said matching property in a user interface.

14. The method of claim 13, further comprising the steps of:
providing notifications to said user and said second user upon identifying said matching property and receiving said plurality of electronic messages.

15. The method of claim 11, wherein said one or more network groups comprise a private network group;
wherein said instructions further cause said processor to create a private network group within said network system;
wherein said private network group comprises a membership requirement.

16. The method of claim 11, further comprising the steps of:
transmitting an invitation from said user to said second user to join said one or more network groups.

17. The method of claim 11, further comprising the steps of:
integrating an email address of an email account associated with said user;
consolidating said plurality of electronic messages into a single conversation thread, wherein said plurality of electronic messages can be transmitted and received via said email address of said email account, SMS, and said messaging platform.

18. The method of claim 11, further comprising the steps of:
sharing calendar events with a plurality of users;
receiving RSVPs for said calendar events from said plurality of users.

19. The method of claim 11, further comprising the steps of:
updating said property listings upon detecting updated information related to said property listings;
displaying said updated information related to said property listings in said one or more network groups.

20. The method of claim 11, further comprising the steps of:
following a second member profile for a second user account associated with said second user;
displaying a user feed comprising one or more communications sent by said second user.
